(19) United States
(12) Patent Application Publication
(10) Pub. No.: US 2005/0102904 A1
(43) Pub. Date: May 19, 2005

(54) System for fabricating custom window shutter assemblies

(76) Inventor: Hsi-Jung Chuang, Cypress, CA (US)

Correspondence Address: SHELDON & MAK, INC, 225 SOUTH LAKE AVENUE, 9TH FLOOR, PASADENA, CA, 91101, US

(21) Appl. No.: 10/715,672

(22) Filed: Nov. 17, 2003

(51) Int. Cl. E06B 7/08

(52) U.S. Cl. 49/74.1

(57) ABSTRACT

A method of manufacturing a custom look shutter assembly to fit an opening, the method having the steps of: a) obtaining a collection of differently sized pre-formed louver assemblies varying in width from a minimum width to a maximum width and varying in height from a minimum height to a maximum height, each louver assembly having a top rail, a bottom rail, a first side rail, and a second side rail; b) forming a frame assembly sized to fit the opening, the frame assembly having a panel opening; c) selecting one of the pre-formed louver assemblies, the selected louver assembly being sized to be accommodated by the panel opening; and d) coupling the selected louver assembly to the frame assembly at the panel opening to form a shutter assembly.

### BACKGROUND

A typical shutter assembly consists of a louver assembly and a frame assembly. Modern windows are often made in standard sizes, so the louver assembly and the frame assembly can be made in several standard sizes. However, older windows and many modern windows are made in custom sizes.

Manufacturing shutters for custom size windows is a time consuming and expensive process. Custom sizing requires that the shutters be made by hand, or that the machines that are used be adjusted depending on the window size, thereby substantially increasing turn around time and reducing the possible efficiencies of mass production. Additionally, because custom shutters are specially made, quality controls obtainable with mass production can be lacking. This lack of quality control can lead to shutters with noticeable defects.

Therefore there is a need for a method of producing shutters for custom sized windows that remedies the above shortcomings.

### SUMMARY OF THE INVENTION

Accordingly, the present invention is directed to a method of manufacturing a custom look shutter assembly to fit an opening. The method, according to an embodiment of the present invention, comprises obtaining a collection of differently sized pre-formed louver assemblies varying in width from a minimum width to a maximum width and varying in height from a minimum height to a maximum height. Each louver assembly has a top rail, a bottom rail, a first side rail, and a second side rail.

The method also comprises forming a frame assembly sized to fit the opening, the frame assembly having a panel opening. One of the pre-formed louver assemblies is selected, the selected louver assembly being sized to be accommodated by the panel opening. The selected louver assembly is coupled to the frame assembly at the panel opening to form a shutter assembly. Optionally, the collection of louver assemblies contains at least 25 differently sized louver assemblies.

Optionally, the louver assembly is modified by removing a portion of at least one of the top rail, the bottom rail, the first side rail, and the second side rail of the selected louver assembly so that the louver assembly fits within the panel opening. Optionally, the at least one rail of the louver assembly having a removed portion is refinished. The present invention is also directed to a shutter assembly produced according to the method described herein.

Additionally, the method can comprise manufacturing a plurality of frame stocks varying in width by a frame stock width interval up until a maximum width difference; and forming at least one of the plurality of frame stocks into the frame assembly sized to fit the opening.

The present invention is also directed to an electronic method for preparing a shutter assembly for an opening, the method comprising: receiving window opening dimensions from a user; receiving a frame style selection from a user; searching a database of information about a plurality of louver assemblies and a plurality of frame stocks for at least one frame stock and at least one louver assembly appropriate for the received window opening dimensions; and reporting appropriate frame stock and louver assembly information to a user.

The present invention is also directed to a container containing a collection of at least 25 differently sized pre-formed louver assemblies varying in width from a minimum width to a maximum width and varying in height from a minimum height to a maximum height, each louver assembly having a top rail, a bottom rail, a first side rail and a second side rail.

### BRIEF DESCRIPTION OF THE DRAWINGS

The features, aspects and advantages of the present invention will become better understood with regard to the following description, appended claims and accompanying figures where:

FIG. 1 is a cross-sectional illustration of a shutter system according to an embodiment of the present invention;

FIG. 2 is a front view of a panel assembly usable with the shutter system of FIG. 1;

FIGS. 3A to 3C are cross-sectional illustrations of differently sized “L-shaped” frame assemblies usable in the shutter system of FIG. 1;

FIGS. 4A to 4C are cross-sectional illustrations of differently sized “Z-shaped” frame assemblies usable in the shutter system of FIG. 1;

FIGS. 5A to 5C are cross-sectional illustrations of differently sized “Deco” frame assemblies usable in the shutter system of FIG. 1;

FIG. 6 is a diagram of a data processing system usable with an electronic method of selecting shutter system components according to an embodiment of the present invention; and

FIG. 7 is a flowchart illustrating the steps in an electronic method of selecting shutter system components according to an embodiment of the present invention.

### DETAILED DESCRIPTION

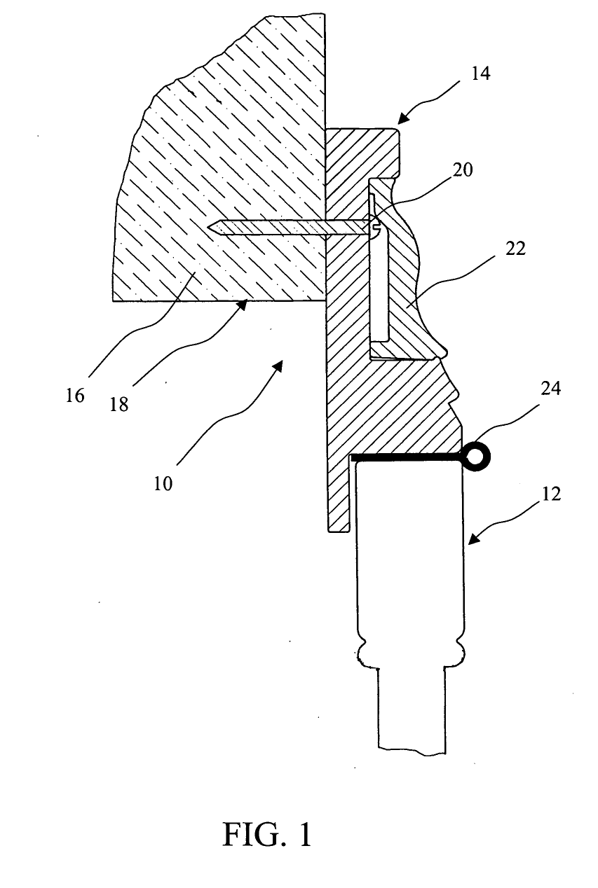

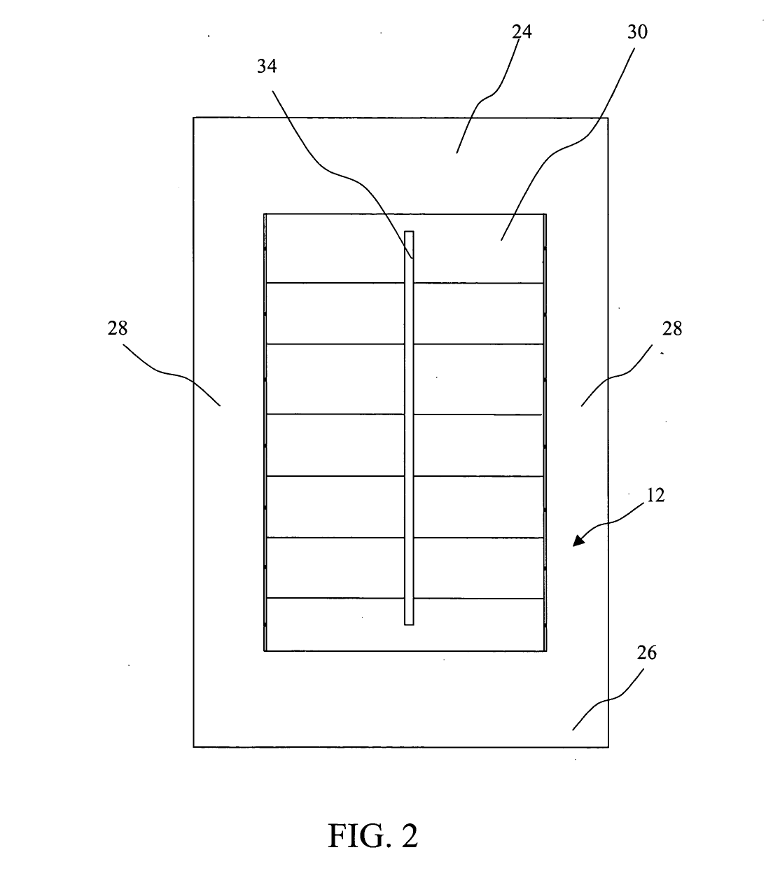

The present invention is directed to a method for producing shutter systems for custom sized windows. As shown in FIGS. 1 and 2, a shutter system 10, according to an embodiment of the present invention, has a louver assembly 12 and a frame assembly 14. The frame assembly is fitted to a wall 16 surrounding a window opening 18 using fasteners 20. The fasteners may be screws, nails, staples, or other known fasteners. Optionally, a cover 22 fits the frame assembly 14 to hide the fasteners 20.

The louver assembly 12 is rotatably attached to the frame assembly 14 by hinges 24. A first portion of each hinge 24 is attached to the louver assembly using a fastener, such as a screw (not shown). A second portion of each hinge is attached to the frame assembly using a fastener (not shown). The first portion of each hinge and the second portion of each hinge are rotatably attached to each other to allow rotation of the louver assembly 12 relative to the frame assembly 14.

The frame assembly 14 has two vertical members and two horizontal members. The two vertical members have a first length and the two horizontal members have a second length. If the shutter system is to be used over a square window then the first and second lengths are equal. Each member has 45 degree mitered ends for assembly with two other members. The frame assembly is typically constructed of wood and finished with paint, varnish, or other wood finish. The frame assembly may optionally be constructed of metal, plastic, or other rigid materials.

As shown in FIG. 2, the louver assembly typically has a top rail 26, a bottom rail 28 and two side rails 30. A plurality of louvers 32 are affixed to the two side rails 28. A tilt bar 34 is attached to the plurality of louvers so that all of the louvers are movable in unison by a user.

Typically, louver assemblies are made from wood, although the assemblies may be made from metal, plastic, or other rigid materials. The louver assemblies may be made with many different numbers and sizes of louvers as determined by the manufacturer.

In order to accommodate custom window sizes of varying widths and heights, the louver assembly, the frame assembly, or both are manufactured in numerous different sizes. An appropriately sized louver assembly is combined with an appropriately sized frame assembly. If necessary, the louver assembly, the frame assembly, or both are modified prior to installation for proper fitting to the custom window size.

According to a preferred embodiment of the present invention, louver assemblies are manufactured in numerous standard sizes. The intervals between sizes varies by louver assembly style depending on the amount that may be removed from the top and bottom rails 24, 26, and from the side rails 28, without harming the look of the louver assembly. For example, for a louver assembly where up to two inches may be removed from each of the top rail 24 and the bottom rail 26, the louver assemblies may be manufactured in sizes with a 4″ height interval and be modifiable to fit any size within the interval.

Depending on the style of louver assembly, the amount removable from the top rail 24 and the bottom rail 26 is variable. Preferably the amount removable from each of the top rail and the bottom rail is from about ¼″ to about 2½″, and more preferably from about 1½″ to about 2″. Preferably the interval of louver assembly heights is between about ½″ and about 5″, and more preferably between about 3″ and about 4″.

Depending on the style of louver assembly, the amount removable from the side rails 28 is variable. Preferably, the amount removable from each of the side rails is from about ¼″ to about 2½″, and more preferably from about ½″ to about 1″. Preferably the interval of louver assembly widths is from about ½″ to about 5″, and more preferably from about ½″ to about 1½″.

In an embodiment of the present invention, a collection of louver assemblies is pre-manufactured with widths varying from a minimum width of about 18″ to a maximum width of about 72″ in width intervals of about 1½″. Additionally, the louver assemblies are made with heights varying from a minimum height of about 36″ to a maximum height of about 72″ in height intervals of about 4″. Therefore, about 300 differently sized panels may be pre-manufactured and kept in stock. Table 1 shows the collection of louver assembly sizes according to this embodiment. If it is determined that a subset of this possible group is more heavily utilized, then more of that subset may be manufactured.

TABLE 1

| Louver Panel Width | Louver Panel Height |
|---|---|
| 18″ | 36″ |
| 18″ | 40″ |
| 18″ | 44″ |
| 18″ | 48″ |
| 18″ | 52″ |
| 18″ | 56″ |
| 18″ | 60″ |
| 18″ | 64″ |
| 18″ | 68″ |
| 18″ | 72″ |
| 19½″ | 36″ |
| . . . | . . . |
| 72″ | 68″ |
| 72″ | 72″ |

However, depending on the style of the louver assembly, the intervals can be greater and the total number of differently sized panels can be reduced accordingly. For example, with widths varying from a minimum width of about 18″ to a maximum width of about 72″ in width intervals of about 11″ and heights varying from a minimum height of about 36″ to a maximum height of about 72″ in height intervals of about 8″, only about 25 panels need to be pre-manufactured. The collection of panels may be pre-manufactured in a first location and shipped in a container to a second location where the shutter assemblies are manufactured.

Depending on the style of louver assembly, portions of the rails may be removed by cutting the rails a desired amount from the outer edge and then refinishing the cut edge. In an embodiment, the cut edge is painted to match the other louver assembly surfaces. Alternatively, if a portion of the rails has is decorative, then the decorative portion may be removed, the necessary amount of the rail cut off, and the decorative portion reattached. The decorative portion may be reattached using, for example, glue or fasteners.

Typically, there are many different styles of frames that may be used with a particular louver assembly. For the sake of explanation three different frame style are illustrated. This list is intended to be illustrative in nature, and is not intended to limit the present invention to the three frame styles illustrated.

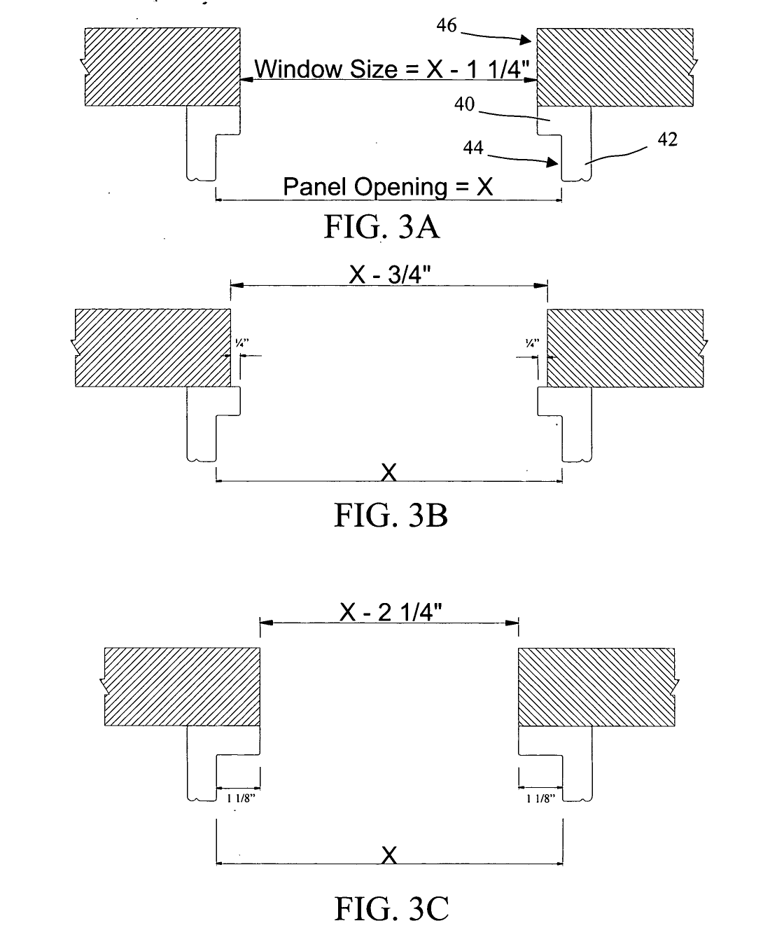

The first frame style illustrated is an “L-shaped” frame. As shown in FIGS. 3A, 3B, and 3C, the “L-shaped” frame has a horizontal mounting surface 40. The “L-shaped” frame has hang strips 42 defining a panel cavity 44 spaced substantially forwardly of the mounting surface.

As shown in FIG. 3A, the “L-shaped” frame is typically mounted so that an edge of the mounting surface 40 is flush with an edge of a window opening 46. The panel cavity 44 is typically larger than the window opening 46. However, in order to accommodate some louver panel sizes, the frame assembly may be mounted so that an edge of the mounting surface 40 extends over a portion of the window opening as shown in FIG. 3B. As shown in FIG. 3B, the frame assembly may be mounted ¼″ over the window opening 46 on both sides to adjust for a manufactured louver assembly that is ½″ too narrow or short. Preferably, each side of the “L-shaped” frame assembly may be mounted to extend the mounting surface up to about 1″ inside the window opening.

Additionally, the length of the mounting surface 40 may be increased to allow for a larger panel cavity, as shown in FIG. 3C. As shown in FIG. 3C, a ½″ increase in the length of the mounting surface allows for use of a 1″ taller or wider louver panel than the frame assembly shown in FIG. 3A. Those skilled in the art will recognize that a combination of differently sized mounting surfaces and mounting over a portion of a window opening allows for large variability in the sizes of louver panels that may be used with a few different sizes of frame stock.

For example, if the louver assembly is manufactured in preselected sizes in width intervals of about 1½″, then the most that the frame assembly will have to compensate for, assuming no modification of the louver assembly, is ¾″ on each side. “L-shaped” frame stock may be manufactured with mounting surface width's varying up to a maximum width difference of about ¾″ at intervals of about ⅛″, in which case 6 different frame stock widths are necessary. Alternatively, “L-shaped” frame stock may be manufactured with mounting surface width's varying up to maximum width difference of about ¾″ at intervals of about 1/16″, in which case 12 different frame stock widths are necessary.

Those skilled in the art will recognize that the maximum width difference is variable as is the width interval. The number of different “L-shaped” frame stocks necessary is dependent on the width and height intervals of the louver assemblies, the amount the louver assembly height and width can be altered, and the amount that the “L-shaped” frame may be mounted to extend over the window opening.

One or more of the four frame sides can be mounted differently from the others. For example, the two side rails may be mounted so that a portion of the mounting surface extends into the window opening to accommodate a louver assembly narrower than the window opening. The top rail and the bottom rail may be mounted with an edge of the mounting surface flush with an edge of the window opening to accommodate a louver assembly taller than the window opening. Additionally, one side rail may be mounted differently than others to offset small differences in height and width and depending on the characteristics of the wall surrounding the window opening. Additionally, two or more frame stocks with different mounting surface widths can be used to form the frame assembly. Additionally, the mounting surface may be narrowed after selection as necessary for a given window opening size and panel size.

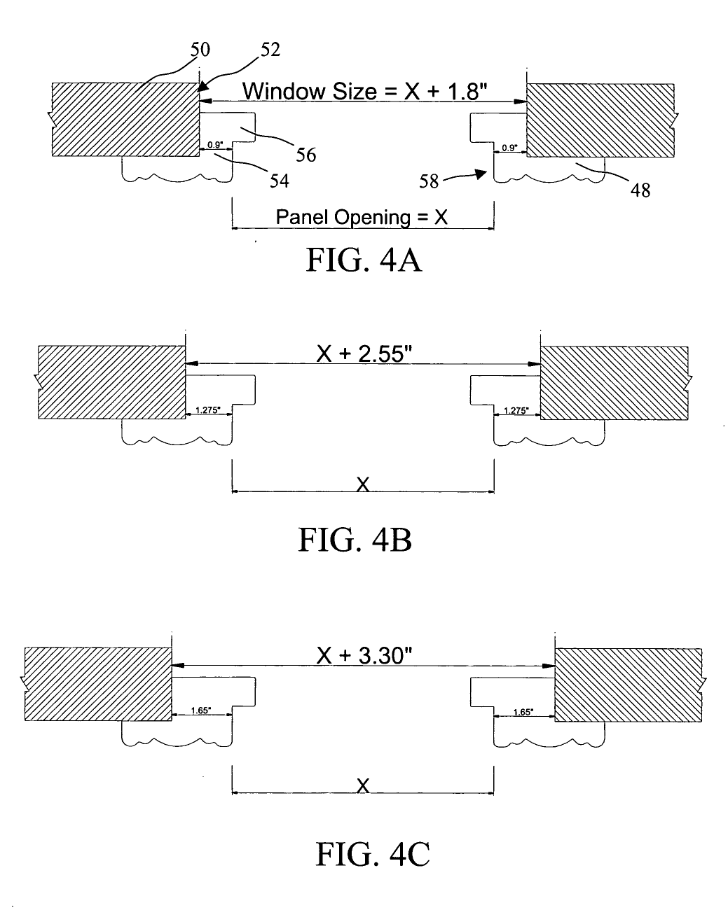

A second frame style usable with the present invention is a “Z-shaped” frame as shown in FIGS. 4A, 4B and 4C. As shown in FIG. 4A, the “Z-shaped” frame has an outer flange 48 that abuts the outside of a wall 50 surrounding a window opening 52. A neck 54 extends from the outer flange 46 inside the window opening 52. An inner flange 56 extends from the neck 54 across a portion of the window opening 52. The neck 54 defines a panel opening 58.

As shown in FIG. 4A, the panel opening 58 is narrower than the window opening 52 by two times the width of the neck 48 of the frame assembly. The same is true of the height of the panel opening 58. As shown in FIGS. 4A and 4B, a ⅜″ increase in the width of the neck 48 creates a ¾″ narrower panel opening 58. Likewise, as shown in FIGS. 4A and 4C, a ¾″ increase in the width of the neck 48 creates a 1½″ narrower panel opening 58.

For example, if the assembly is manufactured in preselected sizes in width intervals of about 1½″, then the most that the frame assembly will have to compensate for, assuming no modification of the louver assembly, is about ¾″ on each side. “Z-shaped” frame stock may be manufactured with necks varying in width up to a maximum width difference of about ¾″ at intervals of about ⅛″, in which case 6 different frame stock widths are necessary. Likewise, “Z-shaped” frame stock may be manufactured with necks varying in width up to a maximum width difference of about ¾″ at intervals of about 1/16″, in which case 12 different frame stock widths are necessary.

Those skilled in the art will recognize that the maximum width difference is variable as is the width interval. The number of different “Z-shaped” frame stocks necessary is dependent on the width and height intervals of the louver assemblies, and the amount the louver assembly height and width can be altered. Additionally, two or more frame stocks with different neck widths can be used to form the frame assembly. Additionally, the neck width can be modified after selection to fit a window opening and provide an appropriately sized panel opening.

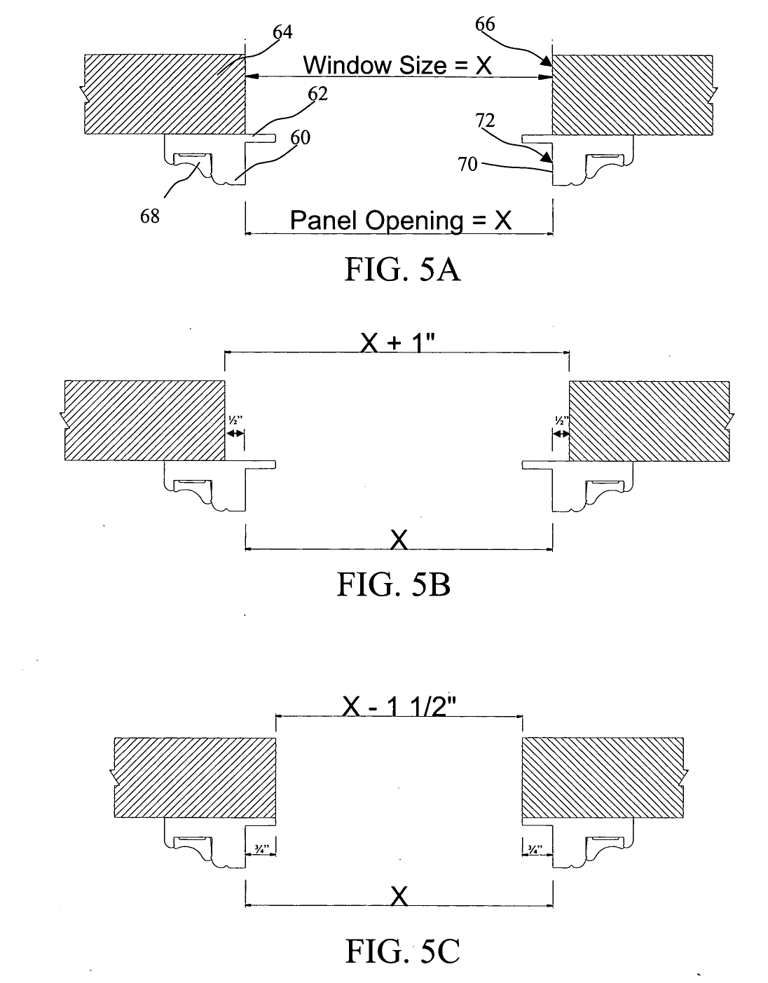

A third frame style usable with the present invention is the “Deco” frame style, as shown in FIGS. 5A, 5B and 5C. As shown in FIG. 5A, the “Deco” frame assembly has a body 60 and a flange 62. The body is mounted to a wall 64 surrounding a window opening 66. A cover 68 covers the fasteners used to mount body 60 to the wall 64. A panel opening 70 is defined by an inner edge 72 of the body 60. Additional information about the “Deco” frame and shutter assembly may be obtained by reference to U.S. Pat. No. 6,474,038, the entire contents of which are hereby incorporated herein by reference.

As shown in FIG. 5A, the body 60 may be mounted to the wall 64 so that the flange 62 extends into the window opening 66, and the inner edge 72 of the body is flush with an edge of the window opening. When the body is mounted as shown in FIG. 5A, the height and width of the panel opening equal the height and width of the window opening. This is an appropriate mounting technique when the louver assembly is approximately equal to the size of the panel opening.

Alternatively, as shown in FIG. 5B, the “Deco” frame assembly may be mounted so that the flange and a portion of the body extend into the window opening. This technique is useful when the louver assembly is smaller than the window opening. As seen in FIG. 5B, when mounting the body so that ½″ extends into the window opening, the louver assembly may be 1″ narrower or shorter than the window opening.

Alternatively, as shown in FIG. 5C, the “Deco” frame assembly may be mounted so that the inner opening and a portion of the flange are positioned outside of the window opening. This technique is useful when the louver assembly is larger than the window opening. As seen in FIG. 5C, when mounting the body so that the ¾″ flange is positioned outside of the window opening, the louver assembly may be 1½″ wider or taller than the window opening.

Like the “L-shaped” frame, it should be noted that less than all 4 frame sides may be mounted the same way. Therefore, the two side rails may be mounted so that a portion of the body extends into the window opening to accommodate a louver assembly narrower than the window opening. The top rail and the bottom rail may be mounted with the inner edge flush with or even outside of the window opening to accommodate a louver assembly taller than the window opening. Additionally, one side rail may be mounted differently than others to offset small differences in height and width and depending on the characteristics of the wall surrounding the window opening.

Because each side of the “Deco” frame assembly is positionable to allow for 1¼″ variation in louver assembly size, thereby allowing for louver panel height and width variation of up to 2½″, it is often unnecessary to manufacture different sizes of “Deco” frame stock.

Typically, a customer or installer measures the dimensions of a rectangular window opening. The customer or installer then decides on the type of frame desired and whether the shutters are to be mounted on the inside or the outside of the window.

Once the customer or installer has measured the dimensions of the window and has decided on the frame type and shutter position, an appropriate frame stock is selected. The frame stock is cut to manufacture a top rail, a bottom rail and side rails, to fit the window opening and to provide a panel opening. A louver assembly is selected from stock, the louver assembly having a height and width to be accommodated by the panel opening. If necessary, the height and/or width of the louver assembly is modified to fit the panel opening.

The frame assembly is installed on the window to be covered by the shutter assembly. The louver assemblies are attached to the frame assembly. The louver assemblies may be attached to the frame assembly prior to installation of the frame assembly.

In selecting the appropriate already manufactured louver assembly for a specific frame type the panel opening possible by the frame style is considered. For example, if a customer has chosen to use a “deco” frame assembly, then the louver assembly can be no more than 1″ narrower or shorter than the window opening, assuming that the base of the frame cannot extend more than ½″ into window opening.

Likewise, the considerations of the customer must be taken into account. For example, a customer may want the frame to cover as little of the window opening as possible. In such a situation where the customer also wants a “deco” frame assembly with a ¾″ flange, then the louver assembly must be at least 1½″ wider and taller than the window opening. Louver assemblies more than 1½″ wider and/or taller than the window opening may be cut to a size 1½″ wider and taller than the window opening.

The present invention is also directed to an electronic method for selecting a pre-manufactured louver assembly and pre-manufactured frame stock components, and for instructing a manufacturer how to modify the louver assembly and/or frame stock to create a shutter assembly for a custom sized window. Depending on the information entered by a user, a computer generates a pick-list of the components needed, the amount to be cut from the width and/or height of the panels if needed, and the mounting location of the frame assembly.

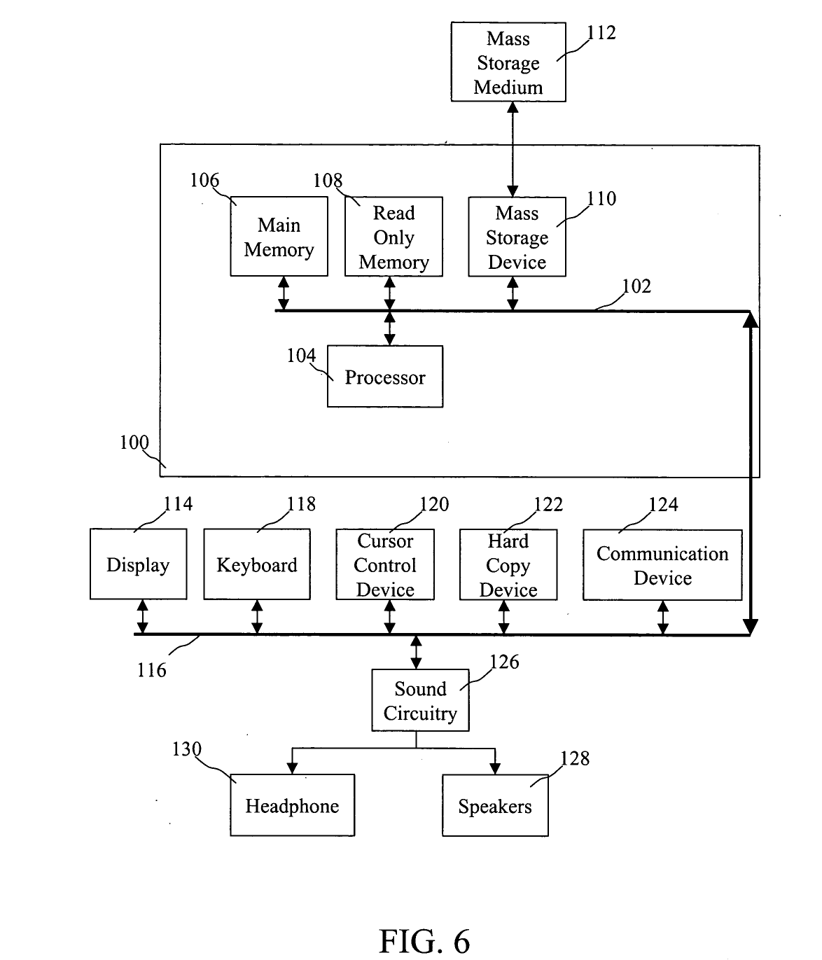

FIG. 6 illustrates a typical data processing system 100 upon which one embodiment of the present invention is implemented. It will be apparent to those of ordinary skill in the art, however that other alternative systems of various system architectures may also be used. The data processing system illustrated in FIG. 6 includes a bus or other internal communication means 102 for communicating information, and a processor 104 coupled to the bus 102 for processing information.

The system further comprises a random access memory (RAM) or other volatile storage device 106 (referred to as main memory), coupled to bus 102 for storing information and instructions to be executed by processor 104. Main memory 106 also may be used for storing temporary variables or other intermediate information during execution of instructions by processor 104. The system also comprises a read only memory (ROM) and/or static storage device 108 coupled to bus 102 for storing static information and instructions for processor 104, and a mass storage device 110 such as a magnetic disk drive or optical disk drive. Mass storage device 110 is coupled to bus 102 and is typically used with a computer readable mass storage medium 112, such as a magnetic or optical disk, for storage of information and instructions.

The system may further be coupled to a display device 114, such as a cathode ray tube (CRT) or a liquid crystal display (LCD) coupled to bus 102 through bus 116 for displaying information to a computer user. An alphanumeric input device 118, including alphanumeric and other keys, may also be coupled to bus 102 through bus 116 for communicating information and command selections to processor 104. An additional user input device is a cursor control 120, such as a mouse, a trackball, stylus, or cursor direction keys coupled to bus 102 through bus 116 for communicating direction information and command selections to the processor 104, and for controlling cursor movement on the display device 114.

Another device which may optionally be coupled to bus 102 through bus 116 is a hard copy device 122 which may be used for printing instructions, data, or other information on a medium such as paper, film, or similar types of media. Optionally, a communication device 124 is coupled to bus 102 through bus 116 for use in accessing other nodes of a network computer system or other computer peripherals. The communication device 124 may include any of a number of commercially available networking peripheral devices such as those used for coupling to an Ethernet, token ring, Internet, or wide area network. The communication device 124 may also include any number of commercially available peripheral devices designed to communicate with remote computer peripherals such as scanners, terminals, specialized printers, or audio input/output devices. The communication device 124 may also include an RS232 or other conventional serial port, a conventional parallel port, a small computer system interface (SCSI) port or other data communication means. The communications device 125 may use a wireless means of data transfer devices such as the infrared IRDA protocol, spread-spectrum, or wireless LAN.

The system may also have sound circuitry 126 either with attached speakers 128 or headphones 130, or with analog audio outputs suitable for input into audio reproduction equipment such as external amplifiers and speakers, cassette adapters, etc. Sound circuitry 126 is well known in the art for playing audio files.

Note that any or all of the components of the system illustrated in FIG. 6 and associated hardware may be used in various embodiments of the present invention; however, it will be appreciated by those of ordinary skill in the art that any configuration of the system may be used for various purposes according to the particular implementation. In one embodiment of the present invention, the data processing system illustrated in FIG. 6 is an IBM® compatible personal computer (PC), an Apple MacIntosh® personal computer, or a SUN® SPARC Workstation. The processor 104 may be one of the 80X86 compatible microprocessors such as the 80486 or PENTIUM® brand microprocessors manufactured by INTEL® Corporation of Santa Clara, Calif.

The software implementing the present invention can be stored in main memory 106, mass storage device 110, or other storage medium accessible to processor 104. It will be apparent to those of ordinary skill in the art that the methods and processes described herein can be implemented as software stored in main memory 106 or read only memory 108 and executed by processor 104. This software may also be resident on an article of manufacture comprising a computer usable mass storage medium 112 having computer readable program code embodied therein and being readable by the mass storage device 110 and for causing the processor 104 to perform digital information library transactions and protocols in accordance with the teachings herein.

The software accesses a database stored in a computer usable mass storage device. All of the louver assembly sizes available are stored in a database. For each louver assembly, the amount that the width and height can be altered, and the method for altering the width and height, is stored in the database.

All of the available frame stock sizes are stored in the database. Additionally, the mounting options of each frame type are stored in the database. The minimum and maximum panel opening height and width changes achievable with the mounting options are stored in the database. The database may be created using database software such as Microsoft Access®.

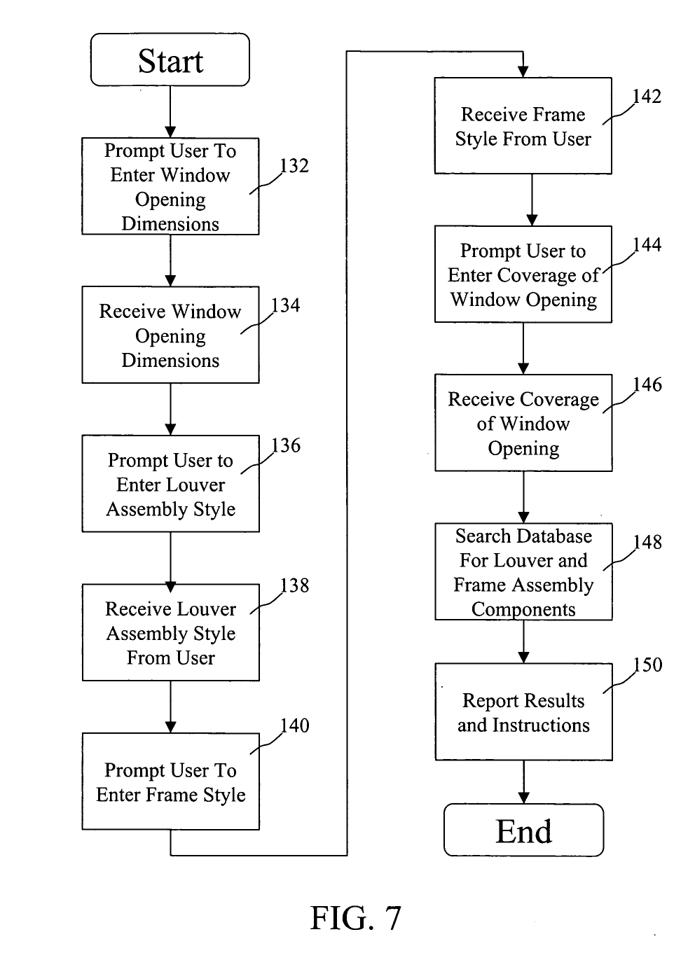

A sequence for an embodiment of the electronic method of the present invention is shown in FIG. 7. First, the system prompts a user to enter the dimensions of the window opening in step 132. The system receives window opening dimensions from the user in step 134. The system then prompts the user to enter lover assembly style information in step 136. Typically, the louver assembly information will include, for example, the number of louvers, the widths of the louvers and the color of the assembly. The system receives louver assembly information in step 138.

The system then prompts the user to enter the desired frame style in step 140. For example, a user will be prompted to select an “L-shaped” frame, a “Z-shaped” frame, or a “deco” frame. The system receives the desired frame style in step 142. The user is then prompted to enter the maximum amount that the customer will tolerate the frame covering the window opening. For those frame styles, such as the “Z-shaped” frame where the frame already covers a portion of a window opening, the user will be prompted to enter the maximum amount of coverage that the customer will tolerate in addition to the minimum amount of coverage required by the frame style. The system receives a window coverage amount in step 144.

It will be appreciated by those skilled in the art that the user does not have to enter all of the above information. However, more information entered by a user leads to more focused results.

Once the user has entered some of the requested information, the system searches the database for louver assemblies and frame stock meeting the criteria of the custom window and the preferences of the user. Optionally, the various options available to the manufacturer are sorted by cost, turnaround time, or an alternative sorting scheme.

If no results are found, then the system presents the user with the option of changing some of the entered criteria to try to find a match. If a louver assembly and frame assembly meeting the entered criteria are found, then the system displays a list of needed parts and manufacturing instructions for the user. In an embodiment of the present invention, the system displays a list of all the possible combinations meeting the users entered criteria and prompts the user to select a combination for more information or for printing.

Typically, the system provides the user with information about the proper louver assembly, such as the dimensions of the assembly as well as any available stock number and location. The system instructs the user as to how much of the top rail, bottom rail, and or side rails needs to be removed as well as the preferred method for removing any necessary amounts. The system also instructs the user on any refinishing needed after any necessary removal, such as the proper paint color to use to repaint any cut surfaces of the louver assembly.

The system instructs the user on the appropriate frame stock, such as the dimensions of the frame stock as well as any available stock number and location. The system provides the user with the cutting lengths necessary to cut the frame stock to make the frame assembly. The system also provides the necessary mounting information, such as how to position the frame stock relative to the window opening on each side of the window.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstract and drawings, and all the steps in any method or process disclosed, may be combined in any combination except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

1. A method of manufacturing a custom look shutter assembly to fit an opening, the method comprising the steps of:
a) obtaining a collection of differently sized pre-formed louver assemblies varying in width from a minimum width to a maximum width and varying in height from a minimum height to a maximum height, each louver assembly having a top rail, a bottom rail, a first side rail, and a second side rail;
b) forming a frame assembly sized to fit the opening, the frame assembly having a panel opening;
c) selecting one of the pre-formed louver assemblies, the selected louver assembly being sized to be accommodated by the panel opening; and
d) coupling the selected louver assembly to the frame assembly at the panel opening to form a shutter assembly.

2. The method of claim 1 wherein before step (d), modifying the louver assembly by removing a portion of at least one of the top rail, the bottom rail, the first side rail, and the second side rail of the selected louver assembly so that the louver assembly fits within the panel opening.

3. The method of claim 2 further comprising refinishing the at least one rail of the louver assembly having a removed portion.

4. The method of claim 1 wherein the collection of louver assemblies comprises at least 25 differently sized louver assemblies.

5. The method of claim 1 wherein:
the minimum width of the louver assemblies is about 18″; and
the maximum width of the louver assemblies is about 72″.

6. The method of claim 5 wherein the width interval is from about ½″ to about 5″.

7. The method of claim 5 wherein the width interval is from about ½″ to about 1½″.

8. The method of claim 1 wherein:
the minimum height of the louver assemblies is about 36″; and
the maximum height of the louver assemblies is about 72″.

9. The method of claim 8 wherein the height interval is from about ½″ to about 5″.

10. The method of clam 8 wherein the height interval is from about 3″ to about 4″.

11. The method of claim 8 wherein up to about 2″ is removable from each of the top rail and the bottom rail of the selected louver assembly.

12. The method of claim 1 wherein a frame assembly portion is mountable over a custom window opening portion to alter the size of the panel opening.

13. A shutter assembly produced according to the method of claim 1.

14. A method of manufacturing a custom look shutter assembly to fit an opening, the method comprising the steps of:
a) obtaining a collection of differently sized pre-formed louver assemblies varying in width from a minimum width to a maximum width and varying in height from a minimum height to a maximum height, each louver assembly having a top rail, a bottom rail, a first side rail, and a second side rail;
b) manufacturing a plurality of frame stocks varying in width by a frame stock width interval up until a maximum width difference;
c) forming at least one of the plurality of frame stocks into a frame assembly sized to fit the opening, the frame assembly having a panel opening;
d) selecting one of the pre-formed louver assemblies, the selected louver assembly being sized to be accommodated by the panel opening; and
e) coupling the selected louver assembly to the frame assembly at the panel opening to form a shutter assembly.

15. The method of claim 14 wherein the collection of louver assemblies comprises at least 25 differently sized louver assemblies.

16. The method of claim 14 wherein:
the frame stock is at least one of L-shaped frame stock and Z-shaped frame stock;
the frame stock width interval is about ⅛″; and
the maximum width difference is about ¾″.

17. The method of claim 14 wherein:
the frame stock is at least one of L-shaped frame stock and Z-shaped frame stock;
the frame stock width interval is about 1/16″; and
the maximum width difference is about ¾″.

18. A method for manufacturing window shutters for a opening having custom dimensions, the method comprising:
a) manufacturing a plurality of louver assemblies varying in width from a minimum width to a maximum width at a width interval and varying in height from a minimum height to a maximum height at a height interval, each louver assembly having a top rail, a bottom rail, a first side rail and a second side rail;
b) manufacturing a plurality of frame stocks varying in width from a frame stock minimum width to a frame stock maximum width at a frame stock width interval;
c) selecting one of the plurality of frame stocks;
d) forming a frame assembly mountable to the window opening, the frame assembly having a panel opening with a width and a height; and
e) selecting a louver assembly having a width and a height about equal to or greater than the panel opening width and the panel opening height.

19. The method of claim 18 further comprising cutting the top rail and the bottom rail of the selected louver assembly so that the height of the louver assembly equals the height of the frame opening.

20. The method for manufacturing window shutters of claim 19 wherein the top and bottom portions of the louver assembly are cut in equal portions.

21. The method for manufacturing window shutters of claim 20 further comprising refinishing the cut top and bottom rails of the louver assembly.

22. A shutter assembly produced according to the method of claim 18.

23. An electronic method for preparing a shutter assembly for an opening, the method comprising:
receiving window opening dimensions from a user;
receiving a frame style selection from a user;
searching a database of information about a plurality of louver assemblies and a plurality of frame stocks for at least one frame stock and at least one louver assembly appropriate for the received window opening dimensions; and
reporting appropriate frame stock and louver assembly information to a user.

24. The electronic method of claim 23 further comprising:
receiving from the user a louver assembly style;
receiving from the user a window coverage amount; and
wherein the searching step further comprises searching the database for at least one frame stock and at least one louver assembly of the received louver assembly style appropriate for the received window opening dimensions minus the received coverage amount.

25. The electronic method of claim 23 further comprising:
reporting an amount to cut each frame stock piece to form an appropriate frame assembly; and
reporting an amount that a louver assembly must be cut on each side to fit a corresponding frame assembly.

26. The electronic method of claim 25 further comprising reporting refinishing steps for refinishing the cut sides of the louver assembly.

27. The electronic method of claim 23 further comprising reporting frame mounting position information.

28. A container containing a collection of at least 25 differently sized pre-formed louver assemblies varying in width from a minimum width to a maximum width and varying in height from a minimum height to a maximum height, each louver assembly having a top rail, a bottom rail, a first side rail and a second side rail.
